(19) United States
(12) Patent Application Publication
(10) Pub. No.: US 2009/0074534 A1
(43) Pub. Date: Mar. 19, 2009

(54) SUPPORTING APPARATUS FOR ELECTRICAL APPARATUS

(75) Inventors: XIU-ZHONG YIN, Shenzhen (CN); HUNG-CHIEH CHANG, Tu-Cheng (TW); LI-PING CHEN, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 11/874,923

(22) Filed: Oct. 19, 2007

(30) Foreign Application Priority Data
Sep. 17, 2007 (CN) 200720201033.8

(51) Int. Cl. F16B 39/284

(52) U.S. Cl. 411/112

(57) ABSTRACT

A supporting apparatus for mounting electrical components, includes a plate, a supporting member and a clamping member. A through hole is defined in the plate. The supporting member includes a shank with a slot defined therein and a cap formed on one end of the shank. The shank is inserted in the hole of the plate from the bottom of the plate to protrude over the top of the plate with the cap resisting against the bottom of the plate. The clamping member defines a locking hole. The clamping member is placed on the top of the plate with the shank inserted in the locking hole of the clamping member. The clamping member is rotatable about the shank between a first position where the shank is movable relative to the clamping member in a lengthwise direction thereof, and a second position where the clamping member is locklingly engaged in the at least one slot of the shank.

### BACKGROUND

1. Technical Field

The present invention relates to a supporting apparatus, more particularly to a supporting apparatus for supporting electrical components thereon.

2. Description of related art

A number of different means and apparatus are used to mount an electrical component such as a mainboard to a plate. One widely used means is to integrally form a base plate, having a plurality of supporting protrusions, from a sheet of metal. An electrical component is then attached to the supporting protrusions of the base plate by a plurality of screws. A significant drawback to this means is that a supporting protrusion cannot be replaced if it breaks. More recent developments have yielded other means for facilitating installation and removal of an electrical component. These include the use of removable support plates.

For example, U.S. Pat. No. 5,145,243 discloses a mounting apparatus that makes assembly of the support plate into the base plate simple, but at the expense of having a substantial amount of additional components and a complex configuration of the fastening structure itself.

### SUMMARY

A supporting apparatus for mounting electrical components, includes a plate, a supporting member and a clamping member. A through hole is defined in the plate. The supporting member includes a shank with a slot defined therein and a cap formed on one end of the shank. The shank is inserted in the hole of the plate from the bottom of the plate to protrude over the top of the plate with the cap resisting against the bottom of the plate. The clamping member defines a locking hole. The clamping member is placed on the top of the plate with the shank inserted in the locking hole of the clamping member. The clamping member is rotatable about the shank between a first position where the shank is movable relative to the clamping member in a lengthwise direction thereof, and a second position where the clamping member is locklingly engaged in the at least one slot of the shank.

Other advantages and novel features of the present invention will become more apparent from the following detailed description of preferred embodiment when taken in conjunction with the accompanying drawings, in which:

### BRIEF DESCRIPTION OF THE DRAWINGS

FIG. 1 is an exploded, isometric view of a supporting apparatus for mounting electrical components thereon in accordance with a preferred embodiment of the present invention, the supporting apparatus including a plate, a clamping member, and a supporting member;

FIG. 2 is an another exploded view of the supporting apparatus of FIG. 1;

FIG. 3 is an assembled view of the supporting apparatus of FIG. 1; and

FIG. 4 is an assembled view of the supporting apparatus with a mainboard mounted thereon.

### DETAILED DESCRIPTION OF THE EMBODIMENT

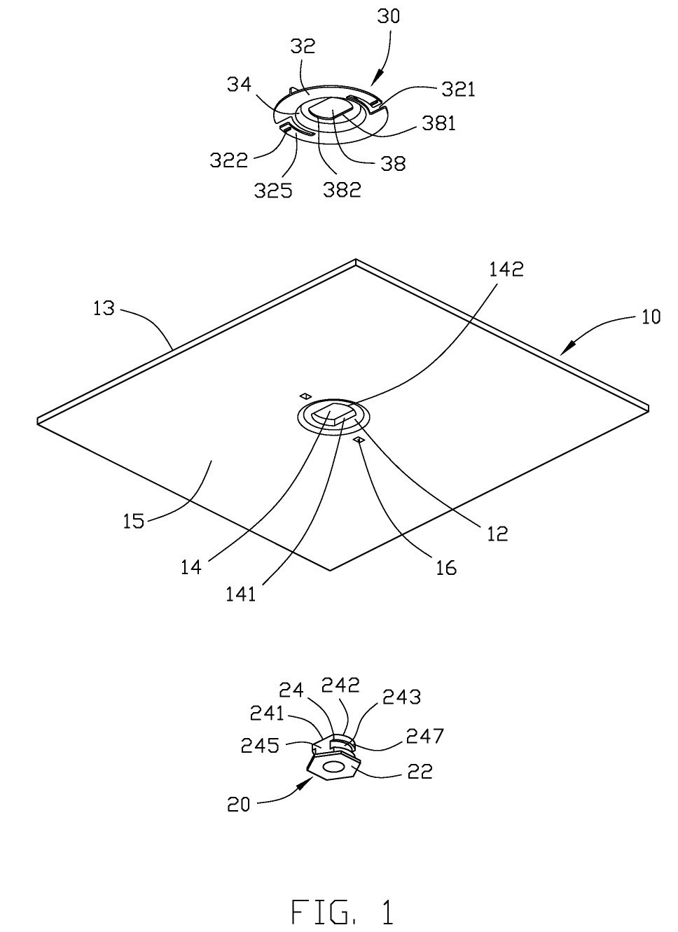

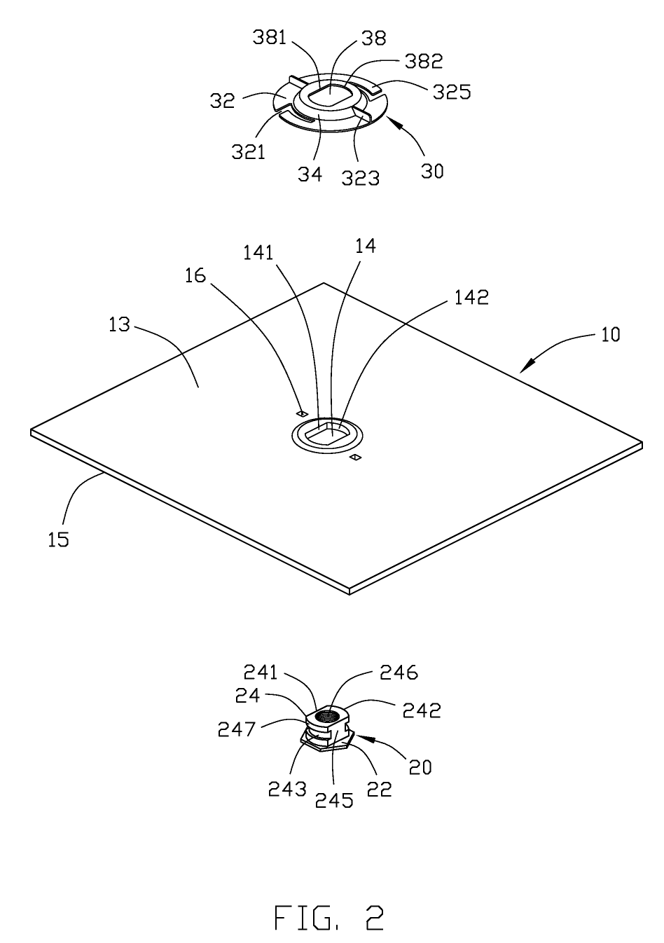

Referring to FIGS. 1 and 2, a supporting apparatus for mounting electrical components in accordance with a preferred embodiment, includes a plate 10, a supporting member 20, and a clamping member 30.

The supporting member 20 comprises a shank 24, a cap 22 formed on one end of the shank 24, and a screw hole 246 defined in the other end of the shank 24. A cross section of the cap 22 is larger than that of the shank 24. The shank 22 comprises two opposite plane sides 245 and two opposite arced sides 247. So the cross section of the shank 22 has two opposite straight line edges 241 and two opposite arced line edges 242. The straight line edge 241 is longer than the arced line edge 242. Each arced side defines a slot 243 therein.

The plate 10 comprises a top 13 and a bottom 15. A recess 12 is defined in the bottom 15 adapted for receiving the cap 22 of the supporting member 20 therein. A through hole 14 is defined in the recess 12 of the plate 10. In cross section, the hole 14 has the same size and shape as the shank 24 in cross section, and has two opposite straight line edges 141 and two opposite arced edges 142. The shape of the cross section of the shank 24 and the hole 14 can be other non-circular shapes, for restricting the shank 24 rotating in the hole 14 after insertion. A pair of positioning holes 16 is defined in the plate 10 beside opposite straight line edges 141 of the recess 12. A straight line from one of the two positioning holes 16 to the other is generally perpendicular to the straight line edges 141 of the hole 14.

The clamping member 30 is generally a circular piece with a protrusion 34 protruding up from a central portion thereof. A hole 38 is defined in the protrusion 34. In cross section, the hole 38 has the same shape as the shank 24 in cross section, and has two opposite straight line edges 381 and two opposite arced edges 382. The distance between the two straight-line edges 381 is less than the distance between the two arced sides 247 of the shank 27, and greater than the distance between the two slots 243 of the shank 27. The clamping member 30 forms a flange 32 encircling the protrusion 34. A pair of “L”-shaped cutouts 321 is defined in the flange 32. Each cutout 321 extends inwardly from an edge of the flange 32 and then along a root of the protrusion 34 to form a tongue piece 325 on the flange 32. The free end of each tongue piece 325 is slightly tilted upwards, and forms a positioning tab 322 on the bottom thereof. A straight line from one of the two positioning tabs 322 to the other is generally parallel to the straight line edges 381 of the hole 38. A pair of reinforcing ribs 323 is formed on top of the flange 32, and connects with the protrusion 34.

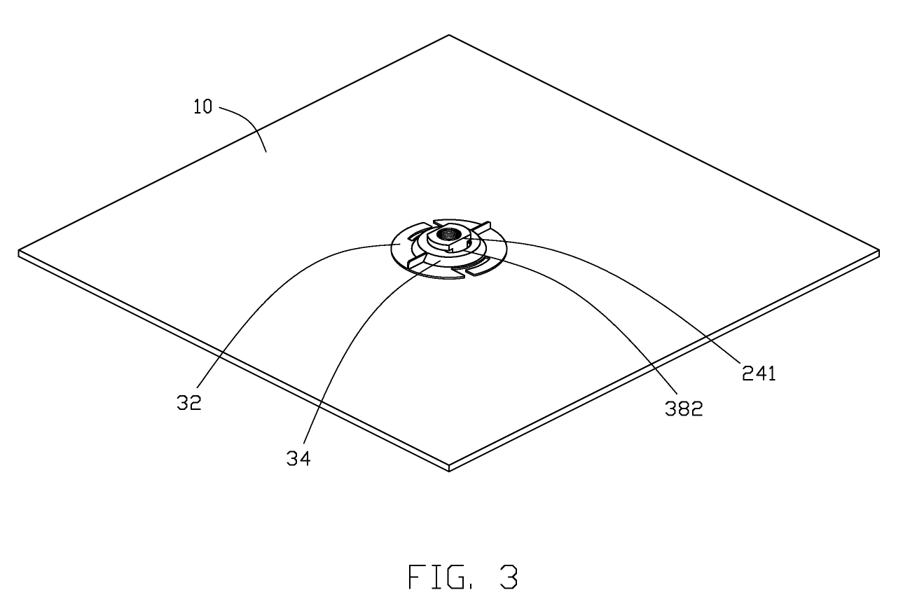

Referring to FIGS. 1 and 3, in assembly of the supporting apparatus, the shank 24 of the of the supporting member 20 is inserted in the hole 14 from the bottom 15 of the plate 10 with the straight line edges 241 of the shank 24 corresponding to the straight line edges 141, and the arced edges 242 corresponding to the arced edges 142. The shank 24 is moved into the hole 14 until the cap 22 of the supporting member 20 resists against the bottom 15 of the plate 10. The shank 24 of the supporting member 20 is protruded over the top 13 of the plate 10. The clamping member 30 is positioned above the shank 24 with the straight line edges 241 of the shank 24 corresponding to the straight line edges 381 of the locking hole 38, and the arced edges 242 corresponding to the arced edges 382. The clamping member 30 is then located about the shank 24 with the shank 24 inserting in the locking hole 38 of the clamping member 30. The flange 32 of the clamping member 30 is located on the top 13 of the plate 10. The positioning tabs 322 are resisted against the plate 10 to slightly deform the free ends of the tongues piece 325. At this position, the arced edges 382 of the hole 38 spatially correspond to the slots 243 of the shank 24.

The clamping member 30 is rotated 90 degrees on the plate 10. The positioning tabs 322 of the clamping member 30 are inserted in the positioning holes 16 of the plate 10 by the elastic force of the tongue pieces 325. The straight line edges 381 of the clamping member 30 are received in the slots 243 of the shank 24, and sandwiched in the slots 243. So the clamping member 30 and the supporting member 20 are clasped with each other to be mounted on opposite sides of the plate 10.

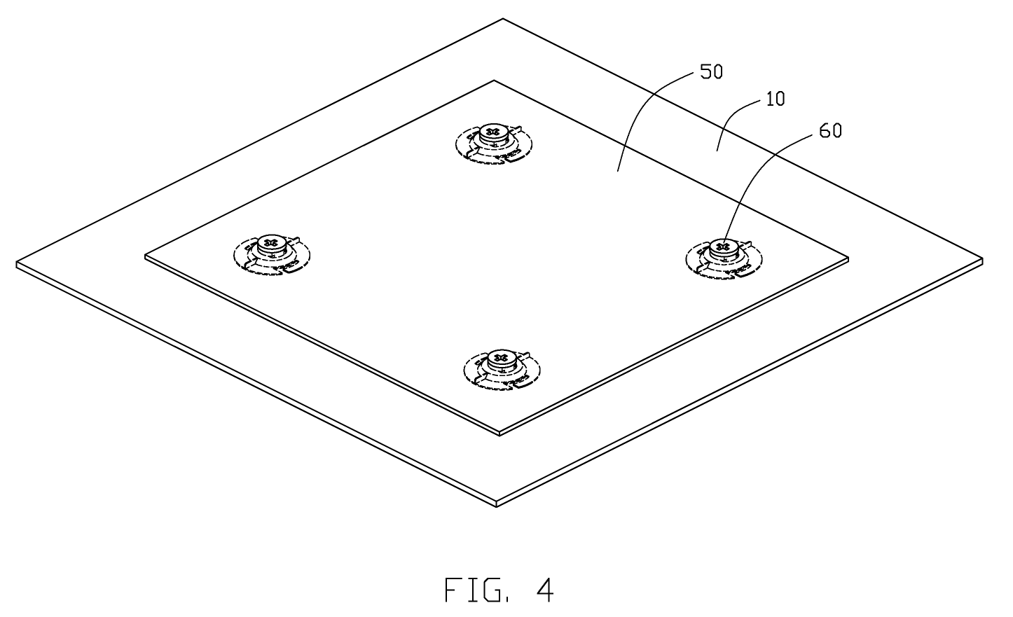

Referring to FIG. 4, for mounting a mainboard 50 on the plate 10, altogether four sets, each set consisting of a clamping member 30 and a supporting member 20, are mounted on the plate 10 in above described manner. The mainboard 50 defines four holes (not shown) at four corners corresponding to the four sets. The four holes of the mainboard 50 are aligned with the four screw holes 246 of the four supporting members 20 respectively. Four screws 60 are screwed in the four screw holes 246 through the four holes of the mainboard 50 to secure the mainboard 50 on the plate 10.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A supporting apparatus for mounting electrical components, comprising:
a plate defining a non-circular through hole, and a positioning hole beside the through hole;
a supporting member comprising a shank and a cap formed on one end of the shank, in cross section, the shank having the same size and shape as the through hole in cross section, the shank being inserted into the through hole of the plate from the bottom of the plate to protrude over the top of the plate to restrict the shank rotating in the through hole of the plate, the cap resisting against the bottom of the plate, the shank defining at least one slot therein; and
a clamping member defining a locking hole, a positioning tab formed on the bottom of the clamping member for resisting against the top of the plate, the clamping member placed on the top of the plate with the shank inserted in the locking hole and the positioning tab resisting against the top of the plate, the clamping member being rotatable about the shank between a first position where the shank is movable relative to the clamping member in a lengthwise direction thereof, and a second position where the clamping member is locklingly engaged in the at least one slot of the shank.

2. The supporting apparatus as described in claim 1, wherein the clamping member comprises a protrusion where the locking hole is defined, and a flange encircling the protrusion, the positioning tab is formed on a bottom of the flange.

3. The supporting apparatus as described in claim 2, wherein a cutout is defined in the flange to form a tongue piece in the flange, and the positioning tab is formed on the free end of the tongue piece.

4. The supporting apparatus as described in claim 3, wherein the cutout is “L”-shaped, and extends inward from the edge of the flange and then along a root of the protrusion to form the tongue piece.

5. The supporting apparatus as described in claim 3, wherein the tongue pieces are elastic, and slightly tilted.

6. The supporting apparatus as described in claim 2, wherein the clamping member defines a recess under the protrusion adapted for receiving the cap therein.

7. The supporting apparatus as described in claim 1, wherein the other end of the shank, which is protruded over the top of the plate, defines a screw hole therein for mounting electrical components.

8. The supporting apparatus as described in claim 1, wherein the shank comprises two opposite sides, the at least one slot includes two slots defined in the two opposite sides, the locking hole comprises first pair of opposite edges, the distance between the first pair of edges is less than the distance between the two opposite sides of the shank, and greater than the distance between the two slots of the shank.

9. The supporting apparatus as described in claim 8, wherein the locking hole comprises second pair of opposite edges for allowing the shank going across there and facing to the two slots of the shank when the clamping member is placed on the top of the plate in the first position, and the two opposite edges of the locking hole is sandwiched in the two slots when the clamping member is in the second position.

10. A supporting apparatus for mounting electrical components, comprising:
a plate with a through hole defined therein;
a supporting member comprising a shank and a cap formed on one end of the shank, the shank inserted in the through hole of the plate from the bottom of the plate to protrude over the top of the plate with the cap resisting against the bottom of the plate, the shank defining a slot therein;
a clamping member defining a locking hole, the clamping member placed on the top of the plate with the shank inserted in the locking hole of the clamping member in a first position, the locking hole comprising a first edge for allowing the shank going across there and facing to the slot of the shank when the clamping member is placed on the top of the plate in the first direction, the locking hole further comprising a second edge sandwiched in the slot after the clamping member is rotated on the plate in a second direction to mount the clamping member and the supporting member on opposite sides of the plate.

11. The supporting apparatus as described in claim 10, wherein the through hole of the plate is non-circular, and in cross section, the shank has same size and shape as the through hole in cross section, to restrict the shank turning in the through hole of the plate.

12. The supporting apparatus as described in claim 10, wherein the clamping member comprises a protrusion where the locking hole is defined, and a flange encircling the protrusion, a positioning tab is formed on the bottom of the flange, and the plate defines a positioning hole adapted for receiving the positioning tab therein after the clamping member rotates in the second direction.

13. The supporting apparatus as described in claim 12, wherein a cutout is defined in the flange to form a tongue piece in the flange, and the positioning tab is formed on the free end of the tongue piece.

14. The supporting apparatus as described in claim 13, wherein the cutout is “L”-shaped, and extends inward from the edge of the flange and then along the root of the protrusion to form the tongue piece.

15. The supporting apparatus as described in claim 13, wherein the tongue pieces are elastic, and slightly tilted.

16. The supporting apparatus as described in claim 12, wherein the clamping member defines a recess under the protrusion adapted for receiving the cap therein.

17. The supporting apparatus as described in claim 10, wherein the other end of the shank, which protrudes over the top of the plate, defines a screw hole therein for mounting electrical components.

18. The supporting apparatus as described in claim 10, wherein the shank comprises two opposite sides each of which defines the slot therein, the locking hole comprises two opposite second edges, a distance between the two second edges is smaller than a distance between the two opposite sides of the shank, and larger than a distance between the two slots of the shank.

19. A supporting apparatus for mounting electrical components, comprising:
a plate defining a through hole and a positioning hole adjacent to the through hole;
a supporting member comprising a shank extending through the through hole and a cap abutting against a first side of the plate, the shank being structured and dimensioned in a manner such that the shank is irrotatably but lengthwise movably engaged in the through hole, the shank having a slot defined therein; and
a clamping member having a locking hole, and a positioning tab, the clamping member placed on an opposite second side of the plate with the shank inserted in the locking hole, the clamping member being rotatable about the shank between a first position where the shank is lengthwise movable relative to the clamping member, and a second position where the clamping member is locklingly engaged in the slot of the shank and the positioning tab is engaged in the positioning hole.
